(19) United States
(12) Patent Application Publication
(10) Pub. No.: US 2024/0384086 A1
(43) Pub. Date: Nov. 21, 2024

(54) COPOLYMER OF (METH)ACRYLIC ACID AND A CYCLIC KETENE ACETAL

(71) Applicants: Rohm and Haas Company, Collegeville, PA (US); Dow Global Technologies LLC, Midland, MI (US)

(72) Inventors: Ligeng Yin, Collegeville, PA (US); Matthew Carter, Bala Cynwyd, PA (US); Stephanie Barbon, Midland, MI (US); Wen-Shiue Young, Blue Bell, PA (US); James Defelippis, Perkiomenville, PA (US)

(21) Appl. No.: 18/692,564

(22) PCT Filed: Nov. 1, 2022
(86) PCT No.: PCT/US2022/048516

§ 371 Date: Mar. 15, 2024

Related U.S. Application Data
(63) Continuation of application No. 63/275,585, filed on Nov. 4, 2021.

(51) Int. Cl. C08L 33/08; C08F 220/18

(52) U.S. Cl. CPC C08L 33/08; C08F 220/1804; C08L 2201/54

(57) ABSTRACT

The present invention relates to a composition comprising an aqueous solution of a copolymer of (meth)acrylic acid and a cyclic ketene acetal monomer. The copolymer is useful as a biodegradable dispersant.

### BACKGROUND OF THE INVENTION

The present invention relates to a copolymer of (meth)acrylic acid and a cyclic ketene acetal, more particularly to an aqueous solution of a copolymer of acrylic acid and 2-methylene-1,3-dioxepane (MDO).

Low molecular weight (MW) polyacrylic acid (PAA) is widely used as a dispersant and a scale-inhibitor in the home care and oil and gas industries. In these applications, PAA generally enters a municipal wastewater treatment plant or is at least partially released into the environment after use. Growing scrutiny from governments, regulatory bodies, companies, and consumers on the fate of polymers in the environment has necessitated the discovery of new, biodegradable materials. Past work has established that PAA is difficult to biodegrade, in part due to the inert nature of its carbon-carbon backbone. On the other hand, PAA oligomers having a molecular weight of less than 1000 g/mole are susceptible to biodegradation. (See Kawai, F., Bacterial Degradation of Acrylic Oligomers and Polymers, Applied Microbiology and Biotechnology 1993, 39 (3), 382-385; Hayashi, T.; Mukouyama, M.; Sakano, K.; Tani, Y., Degradation of a Sodium Acrylate Oligomer by an Arthrobacter sp. Appl Environ Microbiol 1993, 59 (5), 1555-9; Larson, R. J.; Bookland, E. A.; Williams, R. T.; Yocom, K. M.; Saucy, D. A.; Freeman, M. B.; Swift, G., Biodegradation of Acrylic Acid Polymers and Oligomers by Mixed Microbial Communities in Activated Sludge, Journal of environmental polymer degradation 1997, 5 (1), 41-48.) Nevertheless, these biodegradable oligomers are inadequate as dispersants and scale-inhibitors. Strategies for incorporating labile linkages in PAA polymers have been reported. For example, U.S. Pat. No. 4,923,941 (Bailey) discloses the aqueous preparation of a biodegradable MDO-AA copolymer by reacting sodium acrylate with MDO in water containing tetrabutylammonium bromide. Similarly, Guo et al (Guo) reports the preparation of MDO-AA copolymers by reacting incompletely neutralized acrylic acid with MDO in water containing tetrabutylammonium bromide (see Acta Polymerica Sinica 2012, 12, 958-964). Bailey asserts that the evidence of copolymer formation can be confirmed by “the presence of ester linkages in the copolymer chain.” In similar fashion, Guo assigns a triplet peak at δ=4.00 ppm of the disclosed proton NMR spectrum of the polymer product to methylene protons associated with MDO structural units. Notwithstanding Bailey's and Guo's claims, however, the present inventors have confirmed that no detectable amounts of MDO-AA copolymer can be formed by the analogous methods disclosed by Bailey and Guo.

Accordingly, there is still a need in the art of biodegradable dispersants to discover a way to prepare a PAA that is biodegradable yet still effective as a dispersant and scale-inhibitor.

### SUMMARY OF THE INVENTION

The present invention addresses a need in the art by providing a composition comprising an aqueous solution of a copolymer comprising structural units of a) (meth)acrylic acid; and b) a cyclic ketene monomer; wherein the mole-to-mole ratio of structural units of (meth)acrylic acid to structural units of the cyclic ketene monomer is in the range of from 2:1 to 15:1; wherein at least 80 weight percent of the copolymer comprises structural units of (meth)acrylic acid and the cyclic ketene acetal monomer; wherein the cyclic ketene acetal monomer has the following structure:

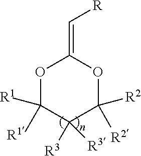

where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R¹′ and R²′ are each independently H or C₁-C₁₂-alkyl; or R′ and R¹′ and/or R² and R²′ form an exocyclic double bond;
with the proviso that when n is 1:
R³ and R³′ are each independently H, C₁-C₁₂-alkyl, phenyl, or R³ and R³′ form an exocyclic double bond or a spirocycloaliphatic group or a spiro-2-methylene-1,3-dioxepane group;
with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

The composition of the present invention provides a copolymer of acrylic acid that is biodegradable, yet effective as a dispersant.

### DETAILED DESCRIPTION OF THE INVENTION

The present invention is a composition comprising an aqueous solution of a copolymer comprising structural units of a) (meth)acrylic acid; and b) a cyclic ketene acetal monomer; wherein the mole-to-mole ratio of structural units of acrylic acid to structural units of the cyclic ketene acetal monomer is in the range of from 2:1 to 15:1; wherein at least 80 weight percent of the copolymer comprises structural units of (meth)acrylic acid and the cyclic ketene acetal monomer;
wherein the cyclic ketene acetal monomer has the following structure:

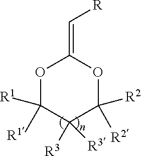

where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R¹′ and R²′ are each independently H or C₁-C₁₂-alkyl; or R¹ and R¹′ and/or R² and R²′ form an exocyclic double bond;
with the proviso that when n is 1:
R³ and R³′ are each independently H, C₁-C₁₂-alkyl, phenyl, or R³ and R³′ form an exocyclic double bond or a spirocycloaliphatic group or a spiro-2-methylene-1,3-dioxepane group;
with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

As used herein, the term “structural unit of (meth)acrylic acid refers to a polymer backbone containing the following repeat units:

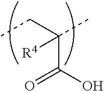

or a salt thereof; where R⁴ is H or CH₃, preferably H.

Reference to structural units of (meth)acrylic acid and salts thereof does not imply that these units arise as a remnant from copolymerization of (meth)acrylic acid (i.e., methacrylic acid or acrylic acid). In fact, the structural units of (meth)acrylic acid present in the copolymer of the present invention advantageously arise from deprotection of t-butyl groups.

The term “structural unit of a cyclic ketene acetal monomer” refers to a polymer backbone containing the following repeat unit:

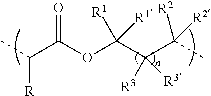

Structural unit of a cyclic ketene acetal monomer where R, R¹, R², R³, R¹′, R²′, R³′, and n are as previously defined.

Examples of cyclic ketene acetal monomers include:

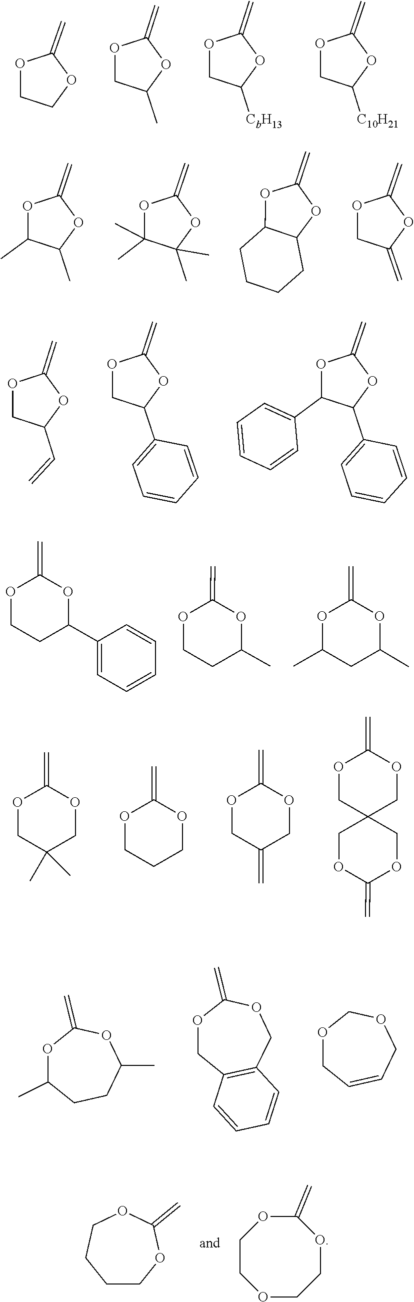

A preferred cyclic ketene acetal monomer is 2-methylene-1,3-dioxepane (MDO).

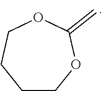

The copolymer of the cyclic ketene acetal monomer and acrylic acid is advantageously prepared in multiple steps. In a first step, a mixture of the cyclic ketene acetal monomer and 1-butyl (meth)acrylate, preferably t-butyl acrylate, is gradually added from a vessel for the monomers (monomer vessel) to a reaction vessel in the presence of an organic solvent. Concurrently, an initiator, which is also advantageously diluted in the same organic solvent as used for the monomers, is gradually added to the reaction vessel from a vessel for the initiator (initiator vessel). It may be desirable to gradually add the mixture of monomers and the initiator to a reaction vessel containing solvent and a small amount of the monomers, which is generally on the order of 10 to 30 weight percent of the total monomers used to prepare the copolymer.

Suitable organic solvents include aliphatic esters such as ethyl acetate; ethers such as tetrahydrofuran and 1,4-dioxane; alkanes such as pentane, hexane, and isododecane; and aromatic solvents such as benzene, toluene, and xylene. Examples of suitable initiators include t-amyl peroxypivalate (commercially available as Trigonox 125-C75 initiator), t-butyl peroxypivalate (commercially available as Trigonox 25-C75), t-amyl peroxy-2-ethylhexanoate; 2,2′-azobis (2-methylbutyronitrile), and dimethyl 2,2′-azobis (2-methyl propionate).

A chain transfer agent such as n-dodecyl mercaptan may also be added concurrent with the monomers and initiator to control the molecular weight of the intermediate and final copolymers. The contents of the reaction vessel are heated to a temperature sufficient to promote copolymerization of the cyclic ketene acetal monomer and t-butyl (meth) acrylate, generally in the range of from 40° C., or from 50° C., to 150° C., or to 100° C., or to 80° C., to yield a solution of an intermediate copolymer of the cyclic ketene acetal monomer and t-butyl (meth)acrylate.

In a second step, the intermediate copolymer is reacted under deprotection conditions to convert t-butyl pendant groups of the copolymer to carboxylic acid groups or salts thereof, thereby forming a solution of a copolymer of the cyclic ketene acetal monomer and (meth)acrylic acid, preferably acrylic acid, or a salt thereof. Deprotection conditions include contacting the intermediate copolymer with an organic acid having pKa preferably in the range of from −2 or −1, to 2 or to 1. Examples of acids suitable for deprotection include trifluoroacetic acid, p-toluenesulfonic acid, trifluoromethanesulfonic acid, and methanesulfonic acid. The organic solution of the copolymer of the cyclic ketene acetal monomer and acrylic acid can then be converted to an aqueous solution of the copolymer of the cyclic ketene acetal monomer and acrylic acid by conventional means such as in vacuo removal of solvents followed by dissolution in water, or by in vacuo removal of solvents followed by dissolution in water, lyophilization, and subsequent re-dissolution in water.

Where the cyclic ketene acetal monomer is MDO, the MDO-AA copolymer has been found to contain two kinds of structural units of MDO, one that is degradable by treatment with a base, and the other that is not readily degradable by treatment with base, as illustrated:

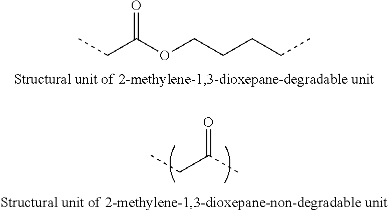

For the copolymer to be useful for the purposes of the present invention, it must contain degradable structural units of the cyclic ketene acetal monomer; although formation of the non-degradable structural units is undesirable, it has proven to be difficult to prepare copolymers without some residual concentration of the non-degradable form.

The mole-to-mole ratio of structural units of (meth)acrylic acid to the structural units of the cyclic ketene acetal monomer (both degradable and non-degradable), preferably MDO, is in the range of from 2:1, or from 3:1, or from 4:1; to 15:1, or to 10:1, or to 8:1 or to 7:1. At least 80, more preferably at least 90 weight percent of the copolymer comprises structural units of (meth)acrylic acid and the cyclic ketene acetal monomer. Preferably, the Mₙ of the desired copolymer is in the range of from 1500 g/mole to 20,000, or to 15,000, or to 10,000 g/mole. Statistically, the polymer backbone is expected to comprise from 2 to 15 structural units of (meth)acrylic acid (preferably fragments of acrylic acid groups) anchored on each end by a single degradable structural unit of the cyclic ketene acetal monomer, as illustrated:

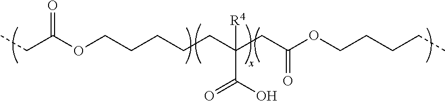

where R⁴ is H or CH₃, preferably H; x is in the range of from 2, or 3, or from 4, to 15, or to 10, or to 8 or to 7; and wherein the dotted lines represent the attachment of the structural unit of the MDO to another fragment of acrylic acid groups.

In an accelerated degradation study, the ester groups are hydrolyzed with a strong base such as KOH to give, in part, a distribution of oligomers including oligomers presumed to have the following structure:

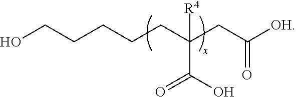

The presence of non-degradable structural units of the cyclic ketene acetal monomer are expected to form copolymers that are hydrolyzable to the following oligomers:

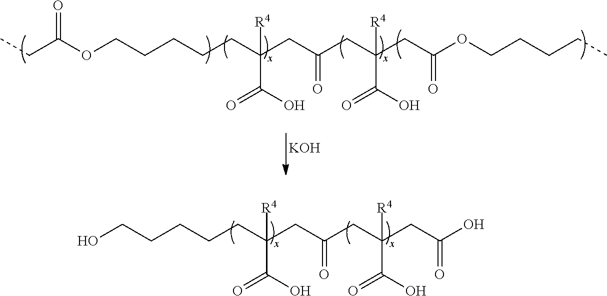

While the exact structures of the oligomers are open to speculation, it can be determined with greater confidence that the number average molecular weight (Mₙ) of hydrolyzed copolymer, as measured by gel permeation chromatography by the method detailed in the Example section, is in the range of from 144, or from 200, or from 400, or from 500 g/mole, to 1000, or to 800, or to 750 g/mole.

Although the composition of the present invention was ostensibly disclosed in U.S. Pat. No. 4,923,941 (Bailey), a repeat of the procedure of Bailey's sole example and proton NMR spectroscopic analysis demonstrated that Bailey's interpretation of the data was erroneous; in fact, no copolymer of MDO and AA can be prepared by the disclosed example.

The example of Bailey was repeated as described, and a proton NMR spectrum of a reaction mixture of sodium acrylate and MDO was recorded after reaction for 30 minutes at 90° C. Triplets at 4.02 ppm and 3.52 ppm were observed, which were consistent with the hydrolyzed product of MDO, 4-hydroxybutyl acetate:

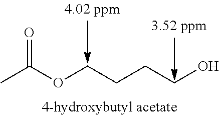

Small triplets at the same resonances were also observed in the proton NMR spectrum of the isolated product. Confirmation that these residual peaks could not be attributable ester formation of a copolymer was demonstrated by diffusion edited proton NMR spectroscopy, which suppresses the chemical shifts of small molecules and reveals only chemical shifts associated with polymers. Significantly, no chemical shifts were observed near 4 ppm, confirming that Bailey could not have formed any detectable levels of a copolymer of AA and MDO by the disclosed method. Moreover, it was further confirmed by proton NMR spectroscopy that MDO hydrolyzed to 4-hydroxybutyl acetate (among other byproducts) under the initial reaction conditions reported by Bailey at room temperature.

Similarly, in Acta Polymerica Sinica 2012, 12, 958-964, Guo claims to have prepared MDO-AA copolymers by reacting incompletely neutralized acrylic acid with MDO in water containing tetrabutylammonium bromide. The method of Guo was repeated as described, and additional experiments were done using acrylic acid at various degrees of neutralization. The method described by Guo could not be reproduced to obtain proton NMR spectroscopic patterns that matched those reported by Guo. On the contrary, NMR spectroscopy showed no detectable amounts of the MDO-AA copolymer. Proton NMR and diffusion NMR spectroscopy revealed a small, sharp triplet resonance at 4.0 ppm, not (as Guo concludes) indicative of the formation of structural units of MDO, rather, characteristic of MDO hydrolysis products, such as 4-hydroxybutyl acetate.

In contrast, copolymers prepared by the process of the present invention and analyzed by diffusion edited proton NMR spectroscopy revealed a strong, broad chemical shift near 4 ppm, consistent with the expected profile of a copolymer containing structural units of a cyclic ketene acetal monomer. The composition of the present invention is useful as a biodegradable dispersant and scale inhibitor.

### EXAMPLES

### Mₙ Determinations

Aqueous samples were prepared for gel permeation chromatography (GPC) at a concentration of about 2 mg/mL in an aqueous 20 mM phosphate buffer at pH 7. The separation was performed on a Waters UPLC system equipped with a refractive index detector, and the same phosphate buffer was used as the mobile phase. An APC column set composed of a TOSOH Bioscience TSKgel G2500PWx1 7.8 mm ID×30 cm, 7-μm column and a TOSOH Bioscience TSKgel GMPWx1 7.8 mm ID×30 cm, 13-μm was used. The flow rate was maintained at 1.0 mL/min and the column temperature at 35° C. Results were calibrated with narrow pAA standards of a peak molecular weight (Mₚ) of 216 g/mol to 1,100,000 g/mol, fitted with a quadratic calibration curve. Standards 1-15 were obtained from American Polymer Standards and Standard 16 (AA trimer with Mₚ=216 g/mol) was prepared internally. The flow rate was 1.0 mL/min and the column temperature was maintained at 35° C. Results were calibrated with narrow pAA standards of a peak molecular weight (Mₚ) of 216 g/mol to 1,100,000 g/mol, fitted with a quadratic calibration curve. Empower Version 3 software (Waters Corporation) was used to calculate Mₙ of the example copolymers.

The GPC calibration table showing retention times of the 16 standards is given in Table 1.

TABLE 1
GPC Calibration Curve

| | Mol Wt | Retention |
|---|---|---|
| | (g/mol) | Time (min) |
| 1 | 1100000 | 11.004 |
| 2 | 782200 | 11.291 |
| 3 | 585400 | 11.532 |
| 4 | 323000 | 11.786 |
| 5 | 193800 | 12.027 |
| 6 | 115000 | 12.397 |
| 7 | 62900 | 12.525 |
| 8 | 47500 | 12.589 |
| 9 | 28000 | 12.747 |
| 10 | 16000 | 13.103 |
| 11 | 7500 | 13.324 |
| 12 | 4100 | 13.473 |
| 13 | 2925 | 13.565 |
| 14 | 1770 | 13.676 |
| 15 | 900 | 13.901 |
| 16 | 216 | 14.613 |

### Proton NMR Spectroscopic Analysis

Proton NMR spectra were obtained using a Bruker NEO 600 MHz spectrometer, equipped with a 5-mm BBO CryoProbe using Bruker zg30 pulse sequences. The relaxation delay for was 12 s. Pulse Field Gradient NMR spectroscopic experiments were carried out using a Bruker ledbpgp2s1d pulse sequence with a gradient pulse length of 2 ms and a delay time of 20 ms.

### Example 1—Preparation of MDO-AA Copolymer

The following procedures were used to prepare a copolymer of MIDO and acrylic acid at approximately a 1:4 mole: mole ratio of MDO: AA structural units.

A. Preparation of MDO-1-Butyl Acrylate Copolymer (1:4 Mole: Mole ratio of MDO:t-Butyl Acrylate)

A three-neck, 250-mL round-bottom flask equipped with a condenser, a stir bar, a thermocouple, and a Y-shaped glass adapter for two polyethylene feed lines was charged with ethyl acetate (18.0 g) and placed on an Opti-chem hotplate stirrer heated to 75° C. A blanket of N₂ was applied and agitation was set to 300 rpm. A first vessel was charged with t-butyl acrylate (24.55 g), MDO (5.45 g), and n-dodecylmercaptan (0.90 g), and a second vessel was charged with Trigonox 125-C75 initiator (0.40 g, 75% active in mineral spirits) in ethyl acetate (7.50 g). A portion of the contents of the first vessel (6.18 g) was added to the reaction flask over 2 min. A few minutes later, the rest of the contents of the first vessel and the contents of the second vessel were metered in the reaction flask at the rates of 0.275 g/min and 0.088 g/min, respectively, so that addition of the contents of the second vessel and the remainder of the first vessel was complete after 90 min. The first vessel was rinsed with ethyl acetate (4.50 g), which was added to the reaction flask. After 15 min, a portion of Trigonox 125-C75 initiator (0.60 g) in ethyl acetate (2.25 g) was metered into reaction flask over 30 min, followed by a 15-min hold, followed by a second addition of the same amount of initiator, also metered into the reaction flask over 30 min. Heating and stirring of the contents of the reaction flask were continued for another 30 min, after which time the reaction was cooled to room temperature. The resultant copolymer was transferred to a glass container for storage without further purification. The solid content was found to be 41.4 wt %. The conversion of both t-butyl acrylate and MDO were determined to be quantitative by proton NMR spectroscopy.

### B. Deprotection of MDO-t-Butyl Acrylate Copolymer

A portion of the copolymer prepared from Part A (5.0 g) was transferred to a 1-oz glass vial fitted with a stir bar. The volatile content was removed by vacuum distillation, after which time the dried polymer was re-dissolved in methylene chloride (CH₂Cl₂, 8.0 g). Trifluoroacetic acid (TFA, 4.4 g) was added dropwise to the stirred contents of the vial. Upon completion of addition, the vial was capped and reaction mixture was stirred at ambient temperature for 18 h. A slightly yellow opaque mixture was obtained.

Volatiles were removed in vacuo then anhydrous tetrahydrofuran (THF, 5.0 g) was added to redissolve the reaction mixture. Volatiles were once again removed in vacuo and the resultant crude product (2.68 g) was dissolved in deionized water (10.26 g) and neutralized with 1 N NaOH solution (5.73 g) to afford a clear solution with a pH of 5.86. The neutralized polymer was dialyzed against deionized water using dialysis membranes with a molecular weight cutoff (MWCO) of 100 to 500 g/mol to remove small-molecule impurities. Lyophilization of the dialyzed solution afforded fluffy, white polymer as the final product. The Mₙ of the product by GPC described hereinabove was 2060 g/mol (polydispersity 4.66). Using proton NMR spectroscopy, the ester content was found to be 18 weight %, ester retention in the polymer backbone was found to be 80 weight %, and residual t-butyl groups in the backbone was found to be 3 mole %.

### Example 2—Preparation of MDO-AA Copolymer

The procedures used to prepare MDO-AA copolymer of Example 2 were substantially the same as described for the preparation of the MDO-AA copolymer of Example 1 except that, for Part A, the amounts of t-butyl acrylate (26.62 g), and MDO (3.38 g), and n-dodecylmercaptan (0.34 g) were altered to ultimately produce an MDO-AA copolymer with an MDO: AA mole: mole ratio of ˜1:7 and an Mₙ of 4080 g/mol (polydispersity 4.61).

### Biodegradation Simulation

The MDO-t-butyl acrylate copolymer of Example 1A was subjected to exhaustive hydrolysis to simulate the biodegradation potential of the MDO-AA copolymer as follows. General-purpose acid-digestion Parr bombs with 23 mL PTFE cups were charged with 4-5 KOH pellets, polymer solution (1 g, 41.4 wt % solids), and ethanol (10 g). The Parr bombs were sealed, transferred to a 150° C. oven, and equilibrated for 3 d. The bombs were removed from the oven and allowed to cool to ambient temperature. Disassembly of the bombs revealed the presence of a liquid portion and a solid portion. The liquid portion was separated and discarded, and the solid portion was diluted with about 5 g of water. The resultant polymer solutions were analyzed by GPC described hereinabove and the Mₙ of the hydrolyzed polymer was found to be 677 g/mole. The hydrolysis studies predict a dramatic reduction in molecular weight from useful MDO-AA copolymers, to biodegradable oligomers.

1. A composition comprising an aqueous solution of a copolymer comprising structural units of a) (meth)acrylic acid; and b) a cyclic ketene acetal monomer; wherein the mole-to-mole ratio of structural units of acrylic acid to structural units of the cyclic ketene acetal monomer is in the range of from 2:1 to 15:1; wherein at least 80 weight percent of the copolymer comprises structural units of (meth)acrylic acid and the cyclic ketene acetal monomer; wherein the cyclic ketene acetal monomer has the following structure: 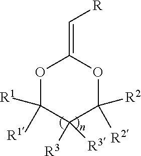
where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R¹′ and R²′ are each independently H or C₁-C₁₂-alkyl; or R′ and R¹′ and/or R² and R²′ form an exocyclic double bond;
with the proviso that when n is 1:
R³ and R³′ are each independently H, C₁-C₁₂-alkyl, phenyl, or R³ and R³′ form an exocyclic double bond or a spirocycloaliphatic group or a spiro-2-methylene-1,3-dioxepane group;
with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

2. The composition of claim 1 wherein the cyclic ketene acetal monomer is selected from the group consisting of:

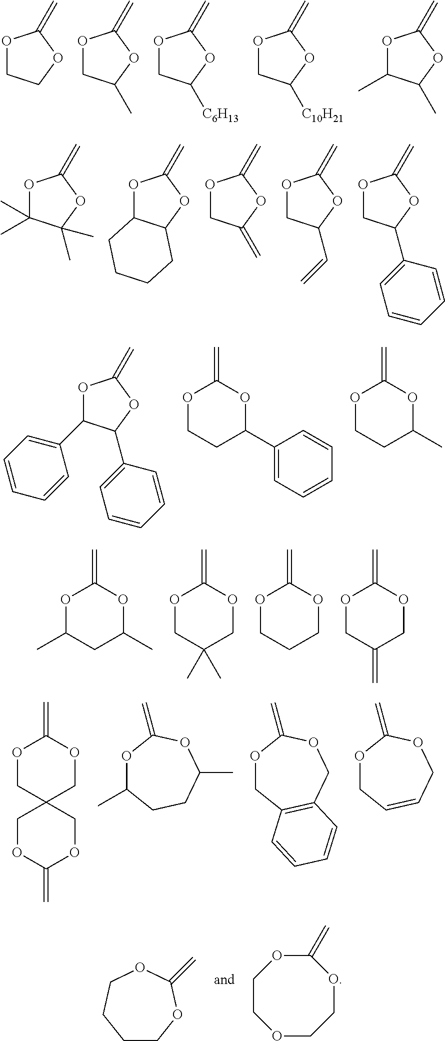

3. The composition of claim 1 wherein the cyclic ketene monomer is 2-methylene-1,3-dioxepane (MDO), and the structural units of (meth)acrylic acid are structural units of acrylic acid, wherein the mole-to-mole ratio of structural units of acrylic acid to structural units of MDO is in the range of from 3:1 to 8:1.

4. The composition of claim 3 wherein the copolymer is hydrolyzable to one or more oligomers having a number average molecular weight (Mₙ) in the range of from 200 g/mol to 800 g/mol by gel permeation chromatography.

5. The composition of claim 3 wherein the copolymer is hydrolyzable to one or more oligomers having an Mₙ in the range of from 400 g/mol to 800 g/mol by gel permeation chromatography.

6. The composition of claim 3 wherein the copolymer is hydrolyzable to one or more oligomers having an Mₙ in the range of from 500 g/mol to 750 g/mol by gel permeation chromatography.

7. The composition of claim 3 wherein the copolymer has an Mₙ in the range of from 1500 g/mol to 10,000 g/mol.

8. The composition of claim 3 wherein the MDO-AA copolymer is hydrolyzable to an oligomer having the following structure: 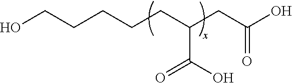
where x is in the range of from 3 to 8.
